(19) United States
(12) Patent Application Publication
(10) Pub. No.: US 2026/0258220 A1
(43) Pub. Date: Sep. 3, 2026

(54) DEGRADABLE RUBBER COMPOSITION, RUBBER MEMBER, SEALING MEMBER, AND METHOD FOR PRODUCING DEGRADABLE RUBBER COMPOSITION

(71) Applicants: KOKOKU INTECH CO., LTD., Tokyo (JP); KUREHA CORPORATION, Tokyo (JP)

(72) Inventors: Tatsuki KOBAYASHI, Inamachi (JP); Kazuhiro TAKAHARA, Inamachi (JP); Takuma KOBAYASHI, Tokyo (JP); Yasushi EBIHARA, Tokyo (JP); Takenori TOSE, Tokyo (JP); Kyosuke KUBOTA, Tokyo (JP)

(21) Appl. No.: 18/997,182

(22) PCT Filed: Jul. 18, 2023
(86) PCT No.: PCT/JP2023/026219

§ 371 Date: Oct. 21, 2025

(30) Foreign Application Priority Data
Jul. 21, 2022 (JP) 2022-116245

(51) Int. Cl. C08K 3/36; C09K 8/42; C09K 8/44

(52) U.S. Cl. CPC C08K 3/36; C09K 8/426; C09K 8/44; C09K 2208/22

(57) ABSTRACT

Provided are a degradable rubber composition with which it is possible to control the time until degradation Starts after the degradable rubber composition is immersed in a fluid such as water, a rubber member, a sealing member, and a method for producing a degradable rubber composition. Disclosed is a degradable rubber composition containing: a degradable rubber component including hydrolyzable rubber molecules; a hydrolysis accelerator accelerating hydrolysis of the rubber molecules upon contact with water; and a hydrolysis inhibitor inhibiting hydrolysis of the rubber molecules, in which the hydrolysis accelerator includes an acidic hydrolysis accelerator that is a powder exhibiting acidic properties upon contact with water, and the acidic hydrolysis accelerator is contained at a content of 40 parts by mass or more with respect to 100 parts by mass of the degradable rubber component.

### TECHNICAL FIELD

The present invention relates to a degradable rubber composition, a rubber member, a sealing member, and a method for producing a degradable rubber composition, and more particularly, the invention relates to a degradable rubber composition with which it is possible to control the time until the degradable rubber composition is degraded after being immersed in a fluid such as water, a rubber member, a sealing member, and a method for producing a degradable rubber composition.

### BACKGROUND ART

Conventionally, a hydraulic fracturing method shown in FIG. 6 has been employed in order to extract hydrocarbon resources such as petroleum and natural gas present in subterranean layers. FIG. 6 is an explanatory diagram illustrating an overview of the hydraulic fracturing method. In the hydraulic fracturing method, first, a subterranean layer 50 is excavated through a well 10 on the ground 11 using a drill or the like, and a borehole 13 is formed down to a mining layer 51 in which hydrocarbon resources confined underground at a great depth, for example, several thousand meters deep, are distributed. Next, the rock mass of the mining layer 51 is fractured by injecting a fluid such as water at a high pressure into the formed borehole 13, and cracks 15 are generated in the rock mass of the mining layer 51. The hydrocarbon resources confined in the mining layer 51 are released through the cracks 15 generated in this manner (see, for example, Patent Document 1).

In the hydraulic fracturing method, in order to generate cracks 15 in the mining layer 51 by fluid pressure, it is necessary to seal the borehole 13 at one or more sites by a sealing member 100 such as a frac plug to form a space sealed by the sealing member 100 in a portion of the borehole 13. At this time, the sealing member 100 needs to suppress the fluid from flowing out of the space.

On the other hand, in order to take out the hydrocarbon resources released by the hydraulic fracturing method through the borehole 13, it is necessary to remove the sealing member 100 from the borehole 13. As a method of facilitating the removal of the sealing member 100 from the borehole 13, there is available a method of using a sealing member 100 that is degraded when exposed to an environment in which a fluid such as water is present, within the borehole 13 over a predetermined period of time. Regarding such a sealing member 100, for example, a sealing member composed of a resin member formed from a degradable resin such as polylactic acid and a rubber member formed from a degradable rubber component, is known.

### CITATION LIST

### Patent Document

Patent Document 1: Japanese Unexamined Patent Publication No. 2015-59376

### SUMMARY OF THE INVENTION

### Problem to be Solved by the Invention

However, although it is known that the time taken for a rubber member formed from the above-mentioned degradable rubber component to be hydrolyzed and disintegrated in an environment in which a fluid such as water is present, can be controlled by adjusting the amount of addition of a degradation accelerator or the like, it is general that the degree of degradation occurs linearly with the lapse of time, and when the period of time between the contact with a fluid such as water and the actual use is lengthened, there is a possibility that the rubber member may lose its function as a sealing member. Therefore, there is a demand for a rubber member with which it is possible to control the time until degradation is initiated after the rubber member is immersed in a fluid such as water.

The present invention was made in view of the above-described circumstances, and it is an exemplary object to provide a degradable rubber composition with which it is possible to control the time until degradation is initiated after the degradable rubber composition is immersed in a fluid such as water, a rubber member, a sealing member, and a method for producing a degradable rubber composition.

### Means for Solving the Problem

In order to address the above-described object, the present invention has the following configurations.

(1) A degradable rubber composition containing: a degradable rubber component including hydrolyzable rubber molecules; a hydrolysis accelerator accelerating hydrolysis of the rubber molecules upon contact with water; and a hydrolysis inhibitor inhibiting hydrolysis of the rubber molecules, wherein the hydrolysis accelerator includes an acidic hydrolysis accelerator that is a powder exhibiting acidic properties upon contact with water, and the acidic hydrolysis accelerator is contained at a content of 40 parts by mass or more with respect to 100 parts by mass of the degradable rubber component.

(2) A degradable rubber composition containing: a degradable rubber component including hydrolyzable rubber molecules; a hydrolysis accelerator accelerating hydrolysis of the rubber molecules upon contact with water; and a hydrolysis inhibitor inhibiting hydrolysis of the rubber molecules, wherein the hydrolysis accelerator includes a basic hydrolysis accelerator that is a powder exhibiting basic properties upon contact with water, and the basic hydrolysis accelerator is contained at a content of 1 part by mass or more with respect to 100 parts by mass of the degradable rubber component.

(3) A rubber member formed from the degradable rubber composition according to the item (1).

(4) A sealing member including the rubber member according to the item (3) as at least a portion thereof.

(5) A method for producing a degradable rubber composition, the method including: a kneading step of kneading a raw material containing a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules, wherein the hydrolysis accelerator includes an acidic hydrolysis accelerator that is a powder exhibiting acidic properties upon contact with water, and the acidic hydrolysis accelerator is contained at a content of 40 parts by mass or more with respect to 100 parts by mass of the degradable rubber component.

(6) A method for producing a degradable rubber composition, the method including: a kneading step of kneading a raw material containing a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules, wherein the hydrolysis accelerator includes a basic hydrolysis accelerator that is a powder exhibiting basic properties upon contact with water, and the basic hydrolysis accelerator is contained at a content of 1 part by mass or more with respect to 100 parts by mass of the degradable rubber component.

Further objects or other features of the present invention will become apparent from preferred embodiments that will be described below with reference to the attached drawings.

### Advantageous Effects of the Invention

According to the present invention, a degradable rubber composition with which it is possible to control the time until degradation is initiated after the degradable rubber composition is immersed in a fluid such as water, a rubber member, a sealing member, and a method for producing a degradable rubber composition can be provided.

### BRIEF DESCRIPTION OF THE DRAWINGS

FIG. 1 is a schematic diagram illustrating a sealing member formed using a degradable rubber composition according to Embodiment 1;

FIG. 2 is a graph showing the results of measuring the surface hardness of rubber samples of Examples 1 and 2 and Comparative Examples 1 to 3;

FIG. 3 is a schematic diagram illustrating the states before and after natural disintegration of a rubber sample of Example 1;

FIG. 4 is a graph showing the temperature dependence of a degradable rubber composition of Example 3;

FIG. 5 is a graph showing the hydrolysis accelerator dependence of a degradable rubber composition of Example 4; and

FIG. 6 is an explanatory diagram illustrating an overview of the hydraulic fracturing method of conventional examples.

### DESCRIPTION OF THE EMBODIMENTS

### Embodiment 1

Hereinafter, a degradable rubber composition according to Embodiment 1 (hereinafter, may be simply referred to as “degradable rubber composition”) will be described.

### Degradable Rubber Composition

The degradable rubber composition contains a degradable rubber component, a hydrolysis accelerator, and a hydrolysis inhibitor and is suitably used as, for example, a material of a rubber member constituting a sealing member used for a hydraulic fracturing method. The rubber member formed using the degradable rubber composition has sealing performance as the rubber member of the sealing member for a first period even when exposed to a fluid such as water. In the present embodiment, the “first period” is a period in which a rubber member formed using a degradable rubber composition maintains the sealing performance as a rubber member of a sealing member even when exposed to a fluid such as water. The first period can be appropriately adjusted to, for example, several days, 5 days, or 7 days, on the basis of the blending composition of the hydrolysis accelerator, the hydrolysis inhibitor, and the like that will be described below.

Furthermore, the rubber member formed using the degradable rubber composition has a feature of disintegrating after being further exposed to a fluid such as water over a second period. Here, the term “second period” means the time taken for a rubber member to disintegrate as a result of the progress of hydrolysis when the rubber member continues to be exposed to a fluid such as water after the first period has elapsed. The second period can be appropriately adjusted to, for example, several days, 4 days, or 6 days, on the basis of the blending composition of the hydrolysis accelerator, the hydrolysis inhibitor, and the like that will be described.

Here, the “disintegrating” of a rubber member means that after the rubber member continues to be exposed to a fluid such as water for a predetermined period of time, the rubber molecules constituting the rubber member are hydrolyzed, and the shape of the rubber member disintegrates. When the temperature conditions are different, the “first period” and the “second period” may also change, and the performance of the rubber member needs to be evaluated under constant conditions. In the present embodiment, the time (first period or second period) until the rubber member disintegrates under constant conditions of being continuously exposed to water at 93° C. is to be evaluated. Conventionally, it is known that the time until the surface hardness (HsA) of a rubber member composed of hydrolyzable rubber molecules becomes 0 (zero), requires a predetermined number of days (for example, for seven days) when the rubber member continues to be exposed to water at 93° C.

Here, the “disintegration” of the rubber member also includes “natural disintegration” of the rubber member. The “natural disintegration” of the rubber member means that after the rubber continues to be exposed to a fluid such as water for a predetermined period of time, the rubber member cannot maintain its shape and disintegrates into small pieces. For example, a case where in a stage in which the hardness of the degradable rubber component becomes 0, the rubber member breaks into small pieces even when no external force is applied, is also included in the natural disintegration. Incidentally, the surface hardness (HsA) of the rubber member becoming 0 (zero) is different from natural disintegration of the rubber member. That is, even when the surface hardness (HsA) of the rubber member becomes 0 (zero), the shape of the rubber member may be maintained, and as long as no force is applied from the outside of the rubber member, the rubber member does not break into small pieces. Hereinafter, each constituent component of the degradable rubber composition will be described in order. The hydraulic fracturing method and the details of the sealing member will be described below.

### Degradable Rubber Component

The degradable rubber component includes hydrolyzable rubber molecules. A hydrolyzable rubber molecule is preferably a rubber molecule having a hydrolyzable functional group in the main chain of the rubber molecule. The rubber molecule may have a hydrolyzable functional group not only in the main chain but also in crosslinked portions. Examples of the hydrolyzable functional group include a urethane group, an ester group, an amide group, a carboxyl group, a hydroxyl group, and a silyl group. The hydrolyzable functional group may be contained in some of the repeating units constituting the rubber molecule, or may be contained in all of the repeating units. Examples of a material containing hydrolyzable rubber molecules include millable rubber materials.

Here, the “millable rubber material” means a kneadable rubber material, that is, a rubber material that can be kneaded. A kneadable type rubber material is a rubber material that is solid at room temperature in the state before vulcanization, and is distinguished from a liquid injectable type rubber material. Since the millable rubber material is solid at room temperature, the millable rubber material is suitable for kneading using, for example, a kneader, a roller, or the like, and even when a large amount of additives in a powder form are added, the additives can be uniformly dispersed in the millable rubber material by kneading. In the case of a liquid injectable type rubber material, since it is a liquid at room temperature, when a large amount of additives in a powder form are added, it may be difficult to uniformly disperse the additives because the solubility limit may be reached, phase separation may occur, or the additives may become lumpy.

The millable rubber material may be a material containing at least one kind selected from the group consisting of urethane rubber, natural rubber, isoprene rubber, ethylene propylene rubber, butyl rubber, styrene rubber, acrylic rubber, aliphatic polyester rubber, and chloroprene rubber. In the present embodiment, thermoplastic elastomers such as polyester-based thermoplastic elastomers and polyamide-based thermoplastic elastomers, which are materials having properties similar to those of the millable rubber material, may also be included in the concept of the millable rubber material.

The mass average molecular weight of the rubber molecules constituting the millable rubber material is preferably, for example, 10000 or more. When the mass average molecular weight is 10000 or more, handling workability of the millable rubber tends to improve. Incidentally, when the mass average molecular weight of the rubber molecules constituting the millable rubber material is adjusted according to the ratio of the hydrolysis accelerator and the hydrolysis inhibitor that will be described below, the time from when the rubber material begins to be exposed to a fluid such as water until the rubber member naturally disintegrates, can be controlled.

The millable rubber material is preferably urethane rubber from the viewpoint of controlling the sealing performance such as hardness and elasticity as the rubber material and controlling the degradation performance and disintegration performance. Examples of the urethane rubber include ester type urethane rubber and ether type urethane rubber; however, an ester type urethane rubber having a hydrolyzable functional group is particularly preferred. Furthermore, in addition to the millable type (kneadable type), the urethane rubber also includes a thermoplastic type and a liquid injectable type; however, since the hydrolysis accelerator that will be described below is a powder, a millable type urethane rubber is preferred in order to incorporate a predetermined amount or more of a hydrolysis accelerator into the degradable rubber composition.

It is preferable that the degradable rubber component includes a millable rubber material as a main ingredient. As long as the characteristics of the millable rubber material utilized in the present embodiment are not affected, the degradable rubber component may also contain a rubber material other than the millable rubber material.

### Hydrolysis Accelerator

A hydrolysis accelerator is a powder exhibiting acidic properties or basic properties upon contact with water and is a component that accelerates hydrolysis of the rubber molecules of the degradable rubber component. Here, the term “powder” means a substance that in a powdered or particulate form at room temperature and in a state not in contact with water (dry state), and the particle size is 200 μm or less. When this powder is brought into contact with water, an aqueous solution thereof exhibits acidic properties or basic properties. Hydrolysis of the rubber molecules is accelerated by this acidic or basic aqueous solution. In the present embodiment, a powder which exhibits acidic properties upon contact with water and which accelerates hydrolysis of the rubber molecules of the degradable rubber component upon contact with water, is referred to as an acidic hydrolysis accelerator. In the present embodiment, a powder which exhibits basic properties upon contact with water and which accelerates hydrolysis of the rubber molecules of the degradable rubber component upon contact with water, is referred to as a basic hydrolysis accelerator.

Examples of the acidic hydrolysis accelerator include mineral-based powders such as silica, clay, talc, aluminum sulfate, barium sulfate, calcium sulfate, and alumina colloid. Incidentally, the acidic hydrolysis accelerator is not limited to mineral-based powders. As the acidic hydrolysis accelerator, these substances may be used singly, or a plurality of substances may be used in combination.

The ratio of the acidic hydrolysis accelerator in the degradable rubber composition is 10 parts by mass or more, preferably 20 parts by mass or more, more preferably 40 parts by mass or more, and particularly preferably 40 parts by mass, with respect to 100 parts by mass of the degradable rubber component. When the ratio of the acidic hydrolysis accelerator is 10 parts by mass or more, degradation of the degradable rubber component is accelerated, the substance obtained after degradation (hereinafter, referred to as degradation product) becomes clay-like, and a clay-like shape is maintained. When the ratio of the acidic hydrolysis accelerator is 20 parts by mass or more, the degradation product disintegrates when subjected to an external force. When the ratio of the acidic hydrolysis accelerator is 40 parts by mass or more, the degradation product naturally disintegrates without the application of an external force. When the ratio of the acidic hydrolysis accelerator in the degradable rubber composition is set to 40 parts by mass or more with respect to 100 parts by mass of the degradable rubber component, a degradable rubber composition constituting a sealing member in which rubber molecules suitably naturally disintegrate when the sealing member continues to be exposed to a fluid such as water for a predetermined period of time, and which can be easily removed by breaking into small pieces even when no external force is applied, can be obtained.

Examples of the basic hydrolysis accelerator include basic oxides such as metal oxide particles, salts of weak acids and strong bases, and metal hydroxides. Examples of the basic oxides include magnesium oxide, potassium oxide, and calcium oxide. Examples of the salts of weak acids and strong bases include sodium carbonate, sodium hydrogen carbonate, and calcium carbonate. Examples of the metal hydroxides include sodium hydroxide and potassium hydroxide. Incidentally, the basic hydrolysis accelerator is not limited to the above-mentioned basic oxides, salts of weak acids and strong bases, and metal hydroxides. As the basic hydrolysis accelerator, these substances may be used singly, or a plurality of substances may be used in combination.

The ratio of the basic hydrolysis accelerator in the degradable rubber composition is 1 part by mass or more with respect to 100 parts by mass of the degradable rubber component. When the ratio of the basic hydrolysis accelerator in the degradable rubber composition is set to 1 part by mass or more with respect to 100 parts by mass of the degradable rubber component, hydrolysis of the rubber molecules is further accelerated when the degradable rubber composition continues to be exposed to a fluid such as water, and the time until the rubber molecules naturally disintegrate can be shortened.

The hydrolysis accelerator may include an acidic hydrolysis accelerator, a basic hydrolysis accelerator, or both of them. As described above, when the acidic hydrolysis accelerator or the basic hydrolysis accelerator is contained in the degradable rubber composition at a content of 40 parts by mass or more with respect to 100 parts by mass of the degradable rubber composition, the acidic hydrolysis accelerator has an effect of bringing natural disintegration of the rubber member, and the basic hydrolysis accelerator has an effect of accelerating the degradation of the rubber member. By appropriately adjusting those effects, the natural disintegration and the degradation rate of the rubber member can be adjusted.

### Hydrolysis Inhibitor

A hydrolysis inhibitor is a component that inhibits the hydrolysis of the rubber molecules, which is accelerated by the hydrolysis accelerator. As the hydrolysis inhibitor, for example, a component that reacts with the carboxylic acid at the end of a carboxyl group generated by hydrolysis of the rubber molecules and inhibits chain progress of the hydrolysis reaction, can be used.

Examples of the hydrolysis inhibitor include polymeric carbodiimide compounds. As the hydrolysis inhibitor, these substances may be used singly, or a plurality of substances may be used in combination.

The nature of the hydrolysis inhibitor is not particularly limited; however, a powdered substance can be used. By using a millable rubber material, a powdered hydrolysis inhibitor can be satisfactorily kneaded.

The ratio of the hydrolysis inhibitor in the degradable rubber composition is preferably 1 part by mass or more with respect to 100 parts by mass of the degradable rubber component. When the ratio of the hydrolysis inhibitor in the degradable rubber composition is appropriately adjusted according to the mass average molecular weight of the millable rubber material and the ratio of the hydrolysis accelerator, hydrolysis of the rubber molecules can be delayed, and the sealing function as a sealing member can be maintained. That is, degradation of the degradable rubber composition can be further delayed by increasing the ratio of the hydrolysis inhibitor in the degradable rubber composition.

### Other Components

The degradable rubber composition may contain, for example, a reinforcing agent as appropriate, in addition to each of the above-mentioned constituent components.

A reinforcing agent is added for the purpose of improving the strength of the rubber member when the degradable rubber composition is used as a sealing member. Examples of the reinforcing agent include silica and carbon black. Incidentally, when a mineral-based powder such as silica is used as the acidic hydrolysis accelerator, the mineral-based powder can accomplish both of the function as an acidic hydrolysis accelerator and the function as a reinforcing agent. Examples of the acidic hydrolysis accelerator include mineral-based powders such as silica, clay, talc, aluminum sulfate, barium sulfate, calcium sulfate, and alumina colloid.

### Method for Producing Degradable Rubber Composition

Regarding the method for producing a degradable rubber composition, any general production method can be employed without particular limitations. That is, the degradable rubber composition can be produced by, for example, a production method including: a kneading step of kneading a raw material including at least a degradable rubber component and an acidic hydrolysis accelerator; and a vulcanization step of subjecting the kneaded raw material to a crosslinking reaction.

A kneading method for kneading the raw material in the kneading step is not particularly limited, and the kneading can be performed by methods such as an open roll, a pressure kneader, and a Banbury mixer.

After obtaining a degradable rubber composition, for example, a production method for producing a rubber member is also not particularly limited. For example, a degradable rubber member can be produced by charging a degradable rubber composition into a predetermined mold and vulcanizing the degradable rubber composition under predetermined vulcanization conditions.

The vulcanization conditions for vulcanizing the degradable rubber composition can be set to, for example, a temperature in the range of 120° C. to 200° C. and a time of about 5 to 60 minutes. When the temperature is lower than 120° C., decomposition of the crosslinking agent does not proceed, and a crosslinking reaction of rubber does not occur. Furthermore, when the temperature is higher than 200° C., deterioration of compounds (polymeric compounds (polymers) ) occurs. On the other hand, at a temperature in the range of 120° C. to 200° C., crosslinking of rubber occurs, and deterioration of polymer does not occur. The same also applies to the range of time. As the vulcanizer, sulfur, an organic peroxide, or the like can be used. Examples of the organic peroxide include a peroxy ketal, a dialkyl peroxide, a diacyl peroxide, and a peroxy ester.

### Hydraulic Fracturing Method

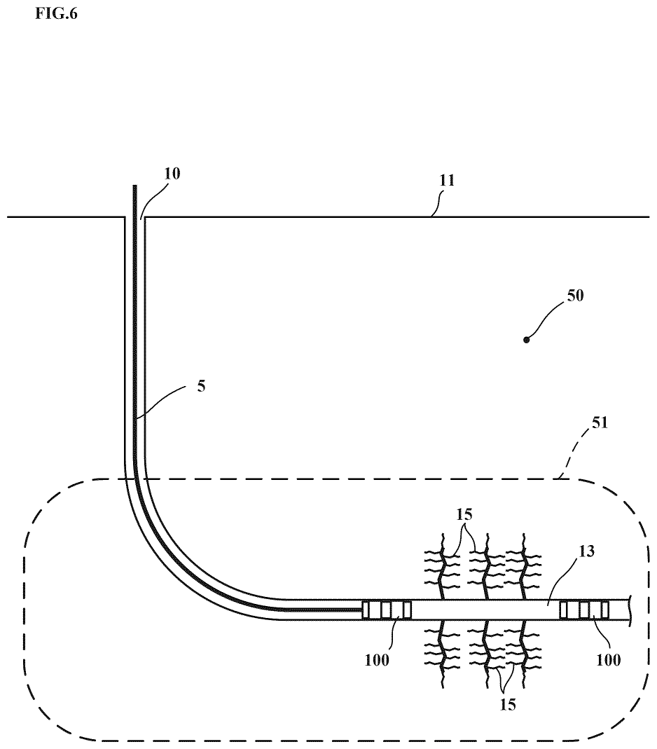

Next, a hydraulic fracturing method will be described. The hydraulic fracturing method, which is one example of using the sealing member of the present embodiment, is similar to the method described in FIG. 6, and as FIG. 6 is incorporated herein by reference, further explanation will not be given. However, as will be described below, the sealing member of the present embodiment is formed using the degradable rubber composition according to the present embodiment, and the material of the rubber member thereof is different from the materials of conventional sealing members 100.

### Sealing Member 1

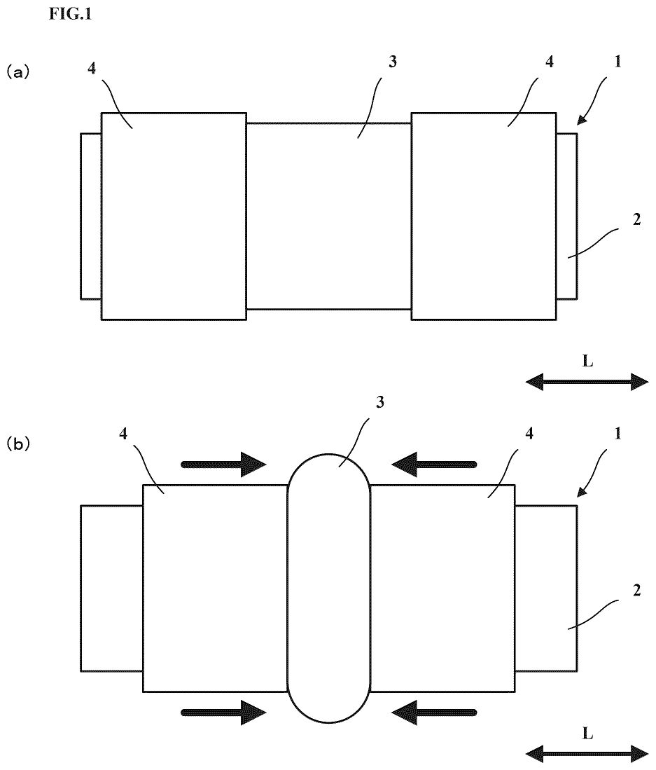

FIG. 1 is a schematic diagram illustrating a sealing member formed using the degradable rubber composition according to Embodiment 1. The sealing member 1 has, for example, as shown in FIG. 1, a body 2 having an approximately cylindrical shape extending in a longitudinal direction L, a pair of sleeves 4 arranged on both end sides in the longitudinal direction L of the body 2 in a slidable manner, and a rubber member 3 arranged between the pair of sleeves 4. FIG. 1(a) is a schematic diagram illustrating a state in which a pair of sleeves 4 are in predetermined positions, and the rubber member 3 is not compressed. FIG. 1(b) is a schematic diagram illustrating a state in which the pair of sleeves 4 have moved to positions toward the central side (toward the rubber member 3) in the longitudinal direction L, and the rubber member 3 has been compressed. Here, the “longitudinal direction L” means the direction in which an approximately cylindrical-shaped tube representing the sealing member 1 stretches and in which the central axis extends, and it is the direction in which the sealing member 1 moves in the borehole 13. Furthermore, the “both end sides in the longitudinal direction L” means the leading edge side and the trailing edge side when the sealing member 1 moves inside the borehole 13.

### Rubber Member 3

The rubber member 3 is a member formed from the degradable rubber composition according to Embodiment 1. The rubber member 3 is a tube-shaped member arranged between a pair of sleeves 4 and covering the periphery of the body 2, as described above. As shown in FIG. 1(b), the rubber member 3 deforms when compressed by the pair of sleeves 4 and expands in a direction approximately orthogonal to the longitudinal direction. As a result, the sealing member 1 undergoes an increase in the diameter (diameter approximately orthogonal to the longitudinal direction) in the portion of the rubber member 3. As the rubber member 3 expands in this manner, the rubber member 3 and the wall surface of the borehole 13 come into close contact with each other, and it is possible to seal the borehole 13.

The sealing member 1 is such that after it has accomplished the role of sealing the borehole 13, the rubber member naturally disintegrates and is removed. The rubber member 3 is formed from the degradable rubber composition according to the present embodiment, and the degradable rubber composition constituting the rubber member 3 of the sealing member 1 has a sealing function as well as a function of breaking into small pieces after a predetermined period of time has elapsed even when no external force is applied. The portions constituting the sealing member 1, which are other than the rubber member 3, that is, the body 2 and the pair of sleeves 4, may be formed from the degradable rubber composition, or may be formed from another degradable material. Examples of such a degradable material include polyglycolic acid (PGA) and polylactic acid (PLA). It is preferable that the portions other than the rubber member 3, which are other than the rubber member 3, are degraded in a period of time approximately equivalent to the degradation time of the degradable rubber composition. Incidentally, the degradable rubber composition of the present embodiment is not limited to the above-mentioned hydraulic fracturing method and may also be used in other methods that require a sealing function, a degradation function, and a disintegration function.

### EXAMPLES

Hereinafter, specific examples of the present invention will be described by way of Examples. Meanwhile, the present invention is not intended to be limited to the following Examples.

### Example 1

100 parts by mass of a polyester-based millable urethane rubber as a degradable rubber component, 40 parts by mass of silica as an acidic hydrolysis accelerator and a reinforcing agent, and 3 parts by mass of a polymeric carbodiimide compound as a hydrolysis inhibitor were used as raw materials. The degradable rubber component was kneaded using an open roll, the hydrolysis accelerator and the hydrolysis inhibitor were added thereto as additives, and the mixture was further kneaded to obtain a degradable rubber composition of Example 1.

The obtained degradable rubber composition was charged into a mold, and was vulcanized by heating under pressure at 120° C. to 200° C. for 60 minutes. An organic peroxide was used as a vulcanizer. In this manner, a rubber sample having a cubic shape with one side measuring 20 mm was produced. A plurality of the rubber samples were produced correspondingly to each immersion time that will be described below.

### Degradability Evaluation Test

Each of the rubber samples and a volume of ion-exchanged water ten times the volume of the rubber sample were placed in a 200-mL glass bottle, and the glass bottle was left to stand for a predetermined immersion time in an oven set such that each of the rubber samples and the ion-exchanged water were kept at 93° C. The immersion time was set to 1 day, 3 days, 5 days, 7 days, 9 days, or 11 days.

Each of the rubber samples that had been left to stand in the oven for each immersion time was taken out from the ion-exchanged water, left to stand at room temperature, and dried. Thereafter, for each of the rubber samples after immersion, the surface hardness (HsA) was measured using a Durometer type A (JIS K 6253, KOBUNSHI KEIKI CO., LTD.). Regarding the surface hardness of the rubber samples after immersion, the value obtained 3 seconds after applying a load of 1 kg was measured. Incidentally, as the surface hardness on day 0, the value measured before the rubber sample was immersed in ion-exchanged water was used.

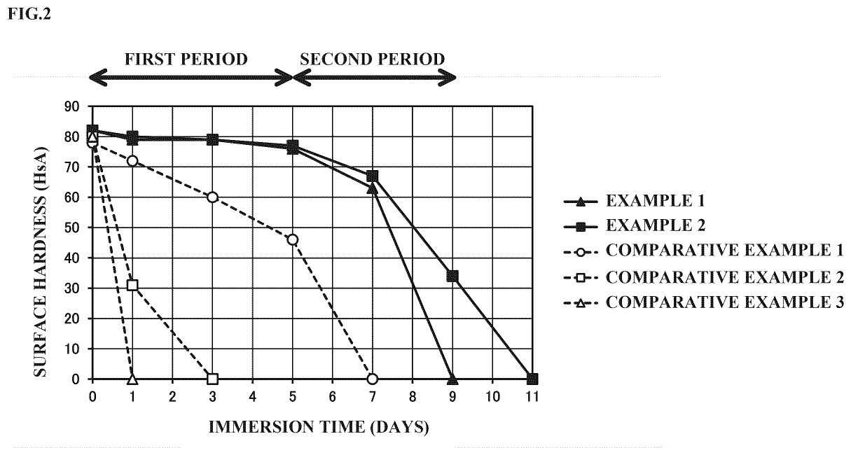

The measurement results of the surface hardness are shown in FIG. 2. FIG. 2 is a graph showing the results of measuring the surface hardnesses of the rubber samples of Examples 1 and 2 and Comparative Examples 1 to 3. In the graph of FIG. 2, the axis of ordinate represents the surface hardness (HsA), and the axis of abscissa represents the immersion time (days). The measurement results of Example 1 are indicated by “▴” (black ▴) in FIG. 2. In the rubber sample of Example 1, the surface hardness is maintained for about five days after the immersion was started, and decreases thereafter. From a comparison with Comparative Example 1 that will be described below, it is speculated that hydrolysis of the rubber member is inhibited up to about the 5^{th} day after the immersion was started, due to the effect of the hydrolysis inhibitor. It can be seen that the surface hardness (HsA) of the rubber sample of Example 1 became 0 (zero) nine days after the immersion was started.

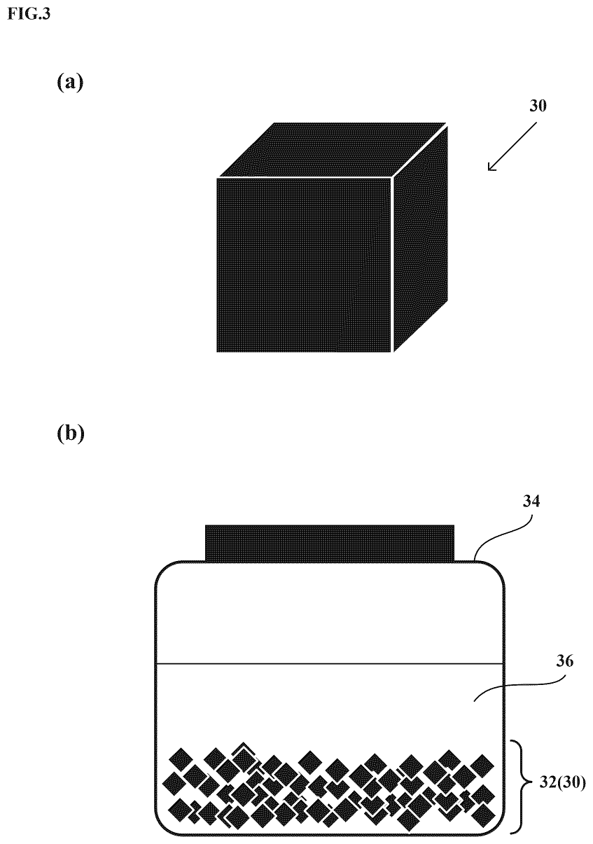

The rubber sample of Example 1 naturally disintegrated as shown in FIG. 3(b) that will be described below, nine days after the immersion was started. From the graph of FIG. 2, it can be seen that the surface hardness of the rubber sample of Example 1 is maintained at about 80 HsA from the start of immersion to about the 5^{th} day, and thereafter, the surface hardness decreases to 0 HsA. From this, it is speculated that in the rubber sample of Example 1, a decrease in the surface hardness was inhibited from the start of immersion to about the 5^{th} day due to the action of the hydrolysis inhibitor, and thereafter, the surface hardness decreased as a result of the progress of hydrolysis of the degradable rubber component. For the rubber sample of Example 1, the first period is the period from the start of immersion to about the 5^{th} day, and the second period is the period from about the 5^{th} day to about the 9^{th} day. In FIG. 2, the first period and the second period for the rubber sample of Example 1 are indicated by two-way arrows.

FIG. 3 is a schematic diagram illustrating the states before and after the natural disintegration of the rubber sample of Example 1. FIG. 3(a) is a schematic diagram illustrating the state immediately after the production of the rubber sample 30. At this time point, the rubber sample 30 maintained a cubic shape with one side measuring 20 mm, and degradation of the degradable rubber component did not proceed. This state before immersion is not limited to Example 1 and is similar in other Examples and Comparative Examples. FIG. 3(b) is a schematic diagram illustrating the state in which the rubber sample 30 of FIG. 3(a) was placed in a glass bottle 34 containing ion-exchanged water 36, and then nine days after the immersion was started, the rubber sample 30 naturally disintegrated. FIG. 3(b) shows the state in which small pieces 32 of the rubber sample 30 that has naturally disintegrated are immersed in the ion-exchanged water 36 at the bottom of the glass bottle 34. The small pieces 32 of the rubber sample 30 that has naturally disintegrated as shown in FIG. 3(b) are fragmented into pieces measuring, for example, 1 mm or less, and are in a powder form when taken out of the glass bottle 34. From these, it can be seen that the rubber sample 30 of Example 1 naturally disintegrated nine days after the immersion was started.

### Example 2

A rubber sample was produced in the same manner as in Example 1, except that 4.5 parts by mass of a polymeric carbodiimide compound as a hydrolysis inhibitor was added to 100 parts by mass of the degradable rubber component, and the surface hardness (HsA) was measured. The measurement results of Example 2 are indicated by “▮” (black quadrangle) in FIG. 2. The surface hardness of the rubber sample of Example 2 is maintained until about five days after the immersion was started and decreases thereafter. From a comparison with Comparative Example 1 that will be described below, it is speculated that hydrolysis of the rubber member is inhibited up to about the 5^{th} day after the immersion was started, due to the effect of the hydrolysis inhibitor. It can be seen that the surface hardness (HsA) of the rubber sample of Example 2 became 0 (zero) eleven days after the immersion was started. The rubber sample of Example 2 naturally disintegrated in the same manner as in Example 1 eleven days after the immersion was started. From this, it can be seen that hydrolysis of the degradable rubber component was inhibited by adding the hydrolysis inhibitor.

From the graph of FIG. 2, it can be seen that the surface hardness of the rubber sample of Example 2 is maintained at about 80 HsA from the start of immersion to about the 5^{th} day, and thereafter, the surface hardness decreases to 0 HsA. From this, it is speculated that in the rubber sample of Example 2, a decrease in the surface hardness was inhibited from the start of immersion to about the 5^{th} day due to the action of the hydrolysis inhibitor, and thereafter, the surface hardness decreased as a result of the progress of hydrolysis of the degradable rubber component. Furthermore, since the rubber sample of Example 2 had a large amount of the hydrolysis inhibitor added as compared to Example 1, it is speculated that even after the 5^{th} day from the start of immersion, hydrolysis was inhibited by the action of the hydrolysis inhibitor, the way of dropping of the surface hardness (slope of the graph) became gentle, and the time from the start of immersion to disintegration was lengthened. For the rubber sample of Example 2, the first period is the period from the start of immersion to about the 5^{th} day, and the second period is the period from about the 5^{th} day to about the 11^{th} day.

### Comparative Example 1

A rubber sample was produced in the same manner as in Example 1, except that the hydrolysis inhibitor was not added, and the surface hardness (HsA) was measured. The measurement results of Comparative Example 1 are indicated by “◯” (white circle) in FIG. 2. It can be seen that the surface hardness (HsA) of the rubber sample of Comparative Example 1 became 0 (zero) after seven days from the immersion was started. Since the rubber sample of Comparative Example 1 did not contain a hydrolysis inhibitor, it is speculated that hydrolysis proceeded immediately after the rubber sample was immersed.

### Comparative Example 2

A rubber sample was produced in the same manner as in Comparative Example 1, except that 5 parts by mass of magnesium oxide, which is a basic hydrolysis accelerator, was used as the hydrolysis accelerator with respect to 100 parts by mass of the degradable rubber component, instead of the acid hydrolysis accelerator (silica), and the surface hardness (HsA) was measured. The measurement results of Comparative Example 2 are indicated by “Δ” (white triangle) in FIG. 2. It can be seen that the surface hardness (HsA) of the rubber sample of Comparative Example 2 became 0 (zero) one day after the immersion was started. Since the rubber sample of Comparative Example 2 did not contain a hydrolysis inhibitor, it is speculated that hydrolysis proceeded immediately after immersion.

Furthermore, since the rubber sample of Comparative Example 2 contained a basic hydrolysis accelerator, it is speculated that hydrolysis was accelerated, and the decrease in the surface hardness occurred rapidly.

### Comparative Example 3

A rubber sample was produced in the same manner as in Comparative Example 1, except that 3 parts by mass of magnesium oxide, which is a basic hydrolysis accelerator, was used as the hydrolysis accelerator with respect to 100 parts by mass of the degradable rubber component, instead of the acidic hydrolysis accelerator (silica), and the surface hardness (HsA) was measured. The measurement results of Comparative Example 2 are indicated by E (white quadrangle) in FIG. 2. It can be seen that the surface hardness (HsA) of the rubber sample of Comparative Example 3 became 0 (zero) three days after the immersion was started. Since the rubber sample of Comparative Example 3 did not contain a hydrolysis inhibitor, it is speculated that hydrolysis proceeded immediately after immersion. Furthermore, since the rubber sample of Comparative Example 3 contained a basic hydrolysis accelerator, it is speculated that hydrolysis was accelerated, and the decrease in the surface hardness occurred rapidly. Since the rubber sample of Comparative Example 3 had a smaller content of the basic hydrolysis accelerator as compared to the rubber sample of Comparative Example 2, it is speculated that the hydrolysis accelerating effect was smaller than that of Comparative Example 2, and the decrease in the surface hardness also did not occur as rapidly as in Comparative Example 2.

From the above results, it was shown that as the degradable rubber composition according to the present invention contains a hydrolysis inhibitor, the degradable rubber composition can form a rubber member in which hydrolysis is inhibited, and the period until disintegration (first period and second period) can be adjusted.

### Example 3: As to Temperature Dependence

The temperature dependence of the degradable rubber composition will be described. As a rubber sample, a sample obtained by using 100 parts by mass of a polyester-based millable urethane rubber as a degradable rubber component and 40 parts by mass of silica as an acidic hydrolysis accelerator and a reinforcing agent as raw materials, was used. Incidentally, a hydrolysis inhibitor was not blended in. Furthermore, a hydrolysis accelerator such as a metal oxide was also not blended in. The temperature of the ion-exchanged water in which the rubber sample was immersed (hereinafter, referred to as water temperature) was set to three temperatures, namely, 73° C., 93° C., and 113° C.

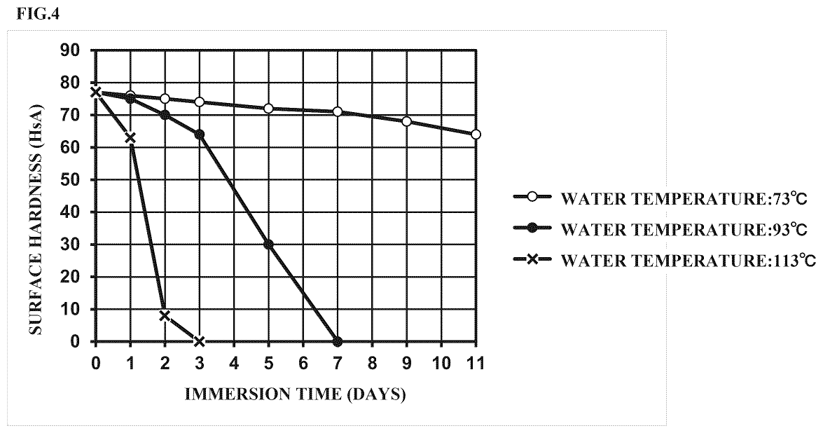

FIG. 4 is a graph showing, by using the above-mentioned rubber sample, how the surface hardness (HsA), which changes with the lapse of time, depends on the water temperature of the ion-exchanged water. The axis of abscissa in FIG. 4 represents the immersion time (days), and the axis of ordinate represents the surface hardness (HsA). Incidentally, in the graph of FIG. 4, when the surface hardness is 0, the degradable rubber composition is deemed to disintegrate. In FIG. 4, the graph represented by “◯” indicates the case where the water temperature is 73° C., the graph represented by “●” indicates the case where the water temperature is 93° C., and the graph represented by “X” indicates the case where the water temperature is 113° C.

The rubber sample immersed in ion-exchanged water at a water temperature of 73° C. maintained a surface hardness (HsA) of 60 or greater even on the 11^{th} day after the immersion was started. The rubber sample immersed in ion-exchanged water at a water temperature of 93° C. maintained a surface hardness (HsA) of 60 or greater up to the 3^{rd} day after the immersion was started; however, after three days, the surface hardness decreased, and the surface hardness (HsA) became 0 on the 7^{th} day. The rubber sample immersed in ion-exchanged water at a water temperature of 113° C. maintained a surface hardness (HsA) of 60 or greater up to the 1^{st} day after the immersion was started; however, after one day, the surface hardness decreased, the surface hardness (HsA) was less than 10 on the 2^{nd} day, and the surface hardness (HsA) was 0 on the 3^{rd} day.

From the above, it was found that time until the disintegration of the degradable rubber composition depends on the temperature of the liquid (ion-exchanged water) in which the rubber sample is immersed. Specifically, it was found that as the temperature of the ion-exchanged water is higher, the time until the disintegration of the rubber sample is shortened.

### Example 4: As to Dependence on Blending Amount of Hydrolysis Accelerator

The dependence on the blending amount of the hydrolysis accelerator in the degradable rubber composition will be described. Regarding the rubber sample, five samples of S1, S2, S3, S4, and S5 were used. Here, a rubber sample S1 has the same blend as that of the above-described Example 3, and further description thereof will not be given. A rubber sample S2 is a product obtained by blending 100 parts by mass of a polyester-based millable urethane rubber with 40 parts by mass of silica as an acidic hydrolysis accelerator and a reinforcing agent and 1 part by mass of a metal oxide as a hydrolysis accelerator. A rubber sample S3 is a product obtained by blending 100parts by mass of a polyester-based millable urethane rubber with 40 parts by mass of silica as an acidic hydrolysis accelerator and a reinforcing agent and 5 parts by mass of a metal oxide as a hydrolysis accelerator. A rubber sample S4 is a product obtained by blending 100 parts by mass of a polyester-based millable urethane rubber with 40 parts by mass of silica as an acidic hydrolysis accelerator and a reinforcing agent and 10 parts by mass of a metal oxide as a hydrolysis accelerator. A rubber sample S5 is a product obtained by blending 100 parts by mass of a polyester-based millable urethane rubber with 40 parts by mass of silica as an acidic hydrolysis accelerator and a reinforcing agent and 20 parts by mass of a metal oxide as a hydrolysis accelerator. Incidentally, no hydrolysis inhibitor was blended in any of the rubber sample S2 to the rubber sample S5 in order to clarify the dependence on the blending amount of the hydrolysis accelerator.

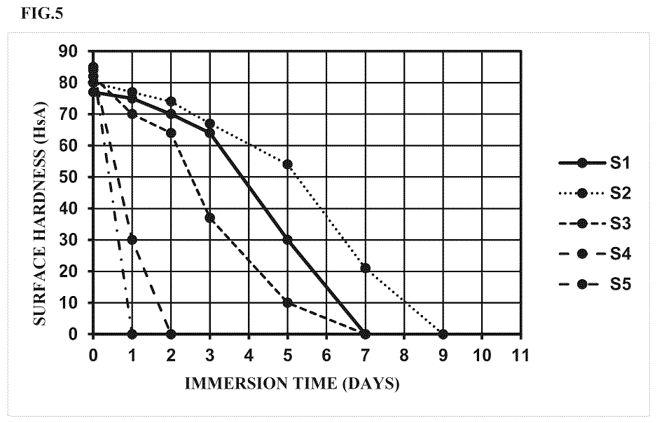

FIG. 5 is a graph showing, using the above-mentioned rubber sample, how the surface hardness that changes with the lapse of time depends on the blending amount of the hydrolysis accelerator. The axis of abscissa in FIG. 5 represents the immersion time (days), and the axis of ordinate represents the surface hardness (HsA). Incidentally, in the graph of FIG. 5, when the surface hardness is 0 HsA, the degradable rubber composition is deemed to disintegrate. In FIG. 5, a solid line represents the rubber sample S1, a dotted line represents the rubber sample S2, a short-dashed line represents the rubber sample S3, a long-dashed line represents the rubber sample S4, and a dashed-dotted line represents the rubber sample S5. Incidentally, the water temperature of the ion-exchanged water was set to 93° C. in all cases.

The rubber sample S1 was similar to the case with a water temperature of 93° C. in Example 3, and further description thereof will not be given. The rubber sample S2 maintained a surface hardness (HsA) of 60 or greater up to the 3^{rd} day after the immersion was started; however, thereafter the surface hardness decreased, and the surface hardness (HsA) became 0 on the 9^{th} day. The rubber sample S3 maintained a surface hardness (HsA) of 60 or greater up to the 2^{nd} day after the immersion was started; however, the surface hardness (HsA) was 40 or less on the 3^{rd} day, the surface hardness (HsA) was 10 on the 5^{th} day, and the surface hardness (HsA) was 0 on the 7^{th} day. In the rubber sample S4, the surface hardness began to decrease immediately after the start of immersion, and the surface hardness (HsA) was 30 on the 1^{st} day, while the surface hardness (HsA) was 0 on the 2^{nd} day. In the rubber sample S5, the surface hardness began to decrease immediately after the start of immersion, and on the 1^{st} day, the surface hardness (HsA) became 0.

From the above, it was found that in the rubber samples S2, S3, S4, and S5, as the blending amount of the hydrolysis accelerator, specifically the metal oxide, in the degradable rubber composition is larger, the time required for the degradation of the degradable rubber composition is shortened. However, it was found that when silica (acidic) and a metal oxide are used in combination, due to the action of neutralization, with a small blending amount (for example, 1 part by mass) of the metal oxide as in the case of the rubber sample S2, the time required for degradation is rather longer (9 days) than the time required for the degradation of the rubber sample S1 in which a metal oxide was not blended (7 days).

As described above, the degradable rubber composition of the present embodiment includes 40 parts by mass of an acidic hydrolysis accelerator as well as a reinforcing agent (for example, silica) with respect to 100 parts by mass of a degradable rubber component (for example, a polyester-based millable urethane rubber). Furthermore, in the degradable rubber composition, by adding a hydrolysis accelerator (for example, a metal oxide) and a hydrolysis inhibitor (for example, a polymeric carbodiimide compound) as additives and adjusting the blending amounts thereof, the first period and the second period can be controlled, and the overall time until disintegration can be controlled.

Thus, preferred embodiments of the present invention have been described; however, the present invention is not limited to these, and various variations and modifications can be made within the scope of the gist thereof. For example, the present invention includes the following objects.

(Object 1) It is intended that a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules, are contained, the hydrolysis accelerator includes an acidic hydrolysis accelerator, which is a powder exhibiting acidic properties upon contact with water, and the acidic hydrolysis accelerator is contained at a content of 40 parts by mass or more with respect to 100 parts by mass of the degradable rubber component.

According to this, there can be provided a degradable rubber composition with which it is possible to control the time until degradation starts after the degradable rubber composition is immersed in a fluid such as water. Furthermore, according to this, hydrolysis can be accelerated until the rubber member naturally disintegrates.

(Object 2) It is intended that a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules, are contained, the hydrolysis accelerator includes a basic hydrolysis accelerator, which is a powder exhibiting basic properties upon contact with water, and the basic hydrolysis accelerator is contained at a content of 1 part by mass or more with respect to 100 parts by mass of the degradable rubber component.

According to this, hydrolysis of the rubber member can be accelerated, and the period until the rubber member disintegrates can be shortened.

(Object 3) The degradable rubber component may include a millable rubber material.

According to this, even when the ratio of the acidic hydrolysis accelerator as a powder is 40 parts by mass or more with respect to 100 parts by mass of the degradable rubber component, the acidic hydrolysis accelerator can be satisfactorily dispersed in the degradable rubber composition.

(Object 4) The mass average molecular weight of the rubber molecules may be 10000 or more.

According to this, a millable rubber material within a size range more suitable for controlling hydrolysis can be selected.

(Object 5) It is intended that the rubber member is formed from any of the degradable rubber compositions according to Object 1 to Object 4.

(Object 6) It is intended that the sealing member includes the rubber member according to Object 5 as at least a portion thereof.

According to Object 5 and Object 6, there can be provided a rubber member that has a sealing function as the rubber member of the sealing member and can be easily removed after being continuously exposed to a fluid such as water over a predetermined period of time, by breaking into small pieces even when no external force is applied, and a sealing member.

(Object 7) It is intended that a kneading step of kneading a raw material containing a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules, is included, the hydrolysis accelerator includes an acidic hydrolysis accelerator, which is a powder exhibiting acidic properties upon contact with water, and the acidic hydrolysis accelerator is contained at a content of 40 parts by mass or more with respect to 100 parts by mass of the degradable rubber component.

(Object 8) It is intended that a kneading step of kneading a raw material containing a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules, is included, the hydrolysis accelerator includes a basic hydrolysis accelerator, which is a powder exhibiting basic properties upon contact with water, and the basic hydrolysis accelerator is contained at a content of 1 part by mass or more with respect to 100 parts by mass of the degradable rubber component.

According to Object 7 and Object 8, there can be provided a method for producing a degradable rubber composition with which it is possible to control the time until the degradable rubber composition is degraded after being immersed in a fluid such as water.

### REFERENCE SIGNS LIST

1, 100: sealing member
2: body
3: rubber member
4: sleeve
5: conduit
10: well
11: ground surface
13: borehole
15: crack
30: rubber sample
32: small piece of rubber sample
34: glass bottle
36: ion-exchanged water
50: subterranean layer
51: mining layer
L: longitudinal direction

1. A degradable rubber composition comprising:
a degradable rubber component including hydrolyzable rubber molecules;
a hydrolysis accelerator accelerating hydrolysis of the rubber molecules upon contact with water; and
a hydrolysis inhibitor inhibiting hydrolysis of the rubber molecules,
wherein the hydrolysis accelerator includes an acidic hydrolysis accelerator that is a powder exhibiting acidic properties upon contact with water, and
the acidic hydrolysis accelerator is contained at a content of 40 parts by mass or more with respect to 100 parts by mass of the degradable rubber component.

2. A degradable rubber composition comprising:
a degradable rubber component including hydrolyzable rubber molecules;
a hydrolysis accelerator accelerating hydrolysis of the rubber molecules upon contact with water; and
a hydrolysis inhibitor inhibiting hydrolysis of the rubber molecules,
wherein the hydrolysis accelerator includes a basic hydrolysis accelerator that is a powder exhibiting basic properties upon contact with water, and
the basic hydrolysis accelerator is contained at a content of 1 part by mass or more with respect to 100 parts by mass of the degradable rubber component.

3. The degradable rubber composition according to claim 1 or 2, wherein the degradable rubber component includes a millable rubber material.

4. The degradable rubber composition according to claim 1, wherein the rubber molecules have a mass average molecular weight of 10000 or more.

5. A rubber member formed from the degradable rubber composition according to claim 1.

6. A sealing member comprising the rubber member according to claim 5 as at least a portion thereof.

7. A method for producing a degradable rubber composition, the method comprising:
a kneading step of kneading a raw material containing a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules,
wherein the hydrolysis accelerator includes an acidic hydrolysis accelerator that is a powder exhibiting acidic properties upon contact with water, and
the acidic hydrolysis accelerator is contained at a content of 40 parts by mass or more with respect to 100 parts by mass of the degradable rubber component.

8. A method for producing a degradable rubber composition, the method comprising:
a kneading step of kneading a raw material containing a degradable rubber component including hydrolyzable rubber molecules, a hydrolysis accelerator accelerating hydrolysis of the rubber molecules upon contact with water, and a hydrolysis inhibitor inhibiting hydrolysis of the rubber molecules,
wherein the hydrolysis accelerator includes a basic hydrolysis accelerator that is a powder exhibiting basic properties upon contact with water, and
the basic hydrolysis accelerator is contained at a content of 1 part by mass or more with respect to 100 parts by mass of the degradable rubber component.
